(19) United States
(12) Patent Application Publication
(10) Pub. No.: US 2006/0178845 A1
(43) Pub. Date: Aug. 10, 2006

(54) Device to record sensor measurement locations

(76) Inventors: Claude Melvin Wiblin, Crownsville, MD (US); Brian David Wiblin, Dallas, TX (US)

Correspondence Address: Claude M. Wiblin, 320 East Forest Trail, Crownsville, MD, 21032, US

(21) Appl. No.: 11/351,168

(22) Filed: Feb. 9, 2006

Related U.S. Application Data
(60) Provisional application No. 60/651,766, filed on Feb. 10, 2005.

(51) Int. Cl. G01B 5/28

(52) U.S. Cl. 702/36

(57) ABSTRACT

A device to record the location, expressed as Cartesian coordinates, of sensor readings, to be attached to a sensor, such as a radiation sensor. The device comprises a plurality of transmitters, a plurality of receivers, processing means, display, and storage means. The processing means calculates the Cartesian coordinates and displays and records the coordinates of each sensor reading.

### CROSS-REFRENCE TO RELATED APPLICATION

This application is entitled to the benefit of U.S. Provisional Patent Application Ser. No. 60/651,766 filed 2005 Feb. 10.

### FEDERALLY SPONSORED RESEARCH

Not Applicable

### SEQUENCE LISTING OR PROGRAM

Not Applicable

### BACKGROUND—FIELD OF INVENTION

This invention relates to ultrasound distance measurement technology.

### BACKGROUND—DESCRIPTION OF PRIOR ART

Ultrasound devices used to measure distance are well known in the prior art. Previous art devices measure distance but these devices do not determine the location using Cartesian coordinates.

One device that tracks the location using ultrasound is identified in U.S. Pat. No. 6,765,491. Another device that tracks location using ultrasound is identified in U.S. Pat. No. 5,631,875. However, these only measure linear distances and do not provide the location of a sensor reading using Cartesian coordinates. They also do not show sensor readings simultaneously recorded at those coordinates.

### OBJECTS AND ADVANTAGES

It is an object of the present invention to record the location of sensor readings as well as the value of the sensor reading. This is useful for locating the presence of contamination or unwanted material such as radioactive contamination. It is also useful for measuring other items such as radiation field strength, temperature, humidity, or any other characteristic that can be measured with a sensor.

Knowing the locations of sensor measurements is also useful for creating visual maps that show where sensor measurements have been taken and the sensor measurement at that location.

Knowing the locations of sensor measurements is also useful for review of real time coordinates of the receiver. It eliminates the need for physical marking and gridding an area.

Another advantage of the present invention is that it works indoors where geographical positioning systems do not.

Another advantage of the present invention is that provides the velocity and path of the sensor.

### SUMMARY

Thus, a main object of the present invention is to track the location of sensor readings and display the readings on a map.

### DRAWINGS

Drawing Figures

FIG. 1 is a perspective view of a transmitter component of the device embodying this invention; where Item 1 is an antenna for transmitting/receiving rf signals. Item 2 is a transducer. Item 3 is a container for circuitry for sending/receiving rf and ultrasound signals.

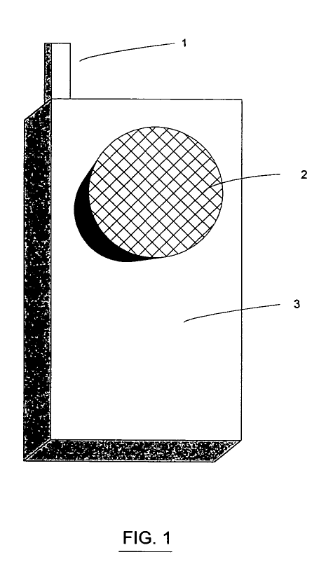

FIG. 2 is a perspective view of a receiver component of the device embodying this invention; where Item 1 is an antenna for transmitting/receiving rf signals. Item 2 is a transducer. Item 3 is a container for circuitry for sending/receiving rf and ultrasound signals. Item 4 is a connecting wire for data transmission from the receiver to a data logger with display. Item 5 is a data logger with display (such as a personal digital assistant illustrated here).

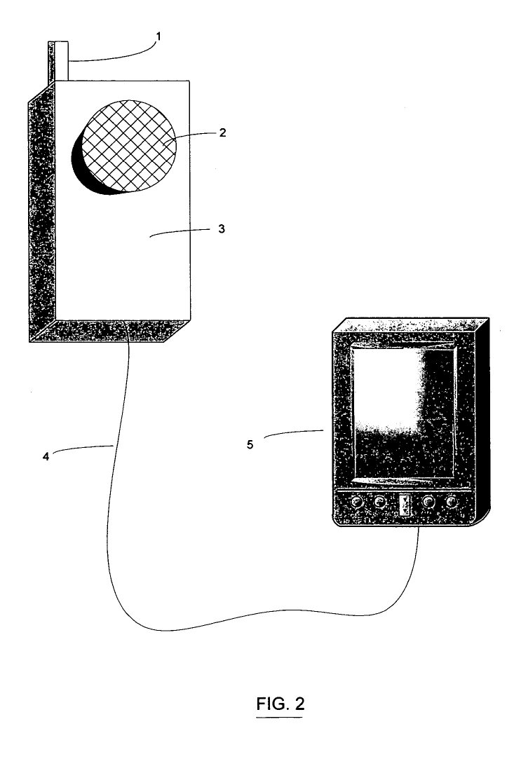

FIG. 3 show the device to record sensor measurement locations. Item 1 is a transmitter with known (X,Y,Z) coordinates. Item 2 is a transmitter with known (X,Y,Z) coordinates. Item 3 is a transmitter with known (X,Y,Z) coordinates. Item 4 is a receiver with (X,Y,Z) coordinates to be determined. Item 5 is any sensor. Item 6 are connecting wires for data transmission. Item 7 is a readout device (PDA is illustrated). Item 8 are indications of ultrasound or rf transmission to the receiver.

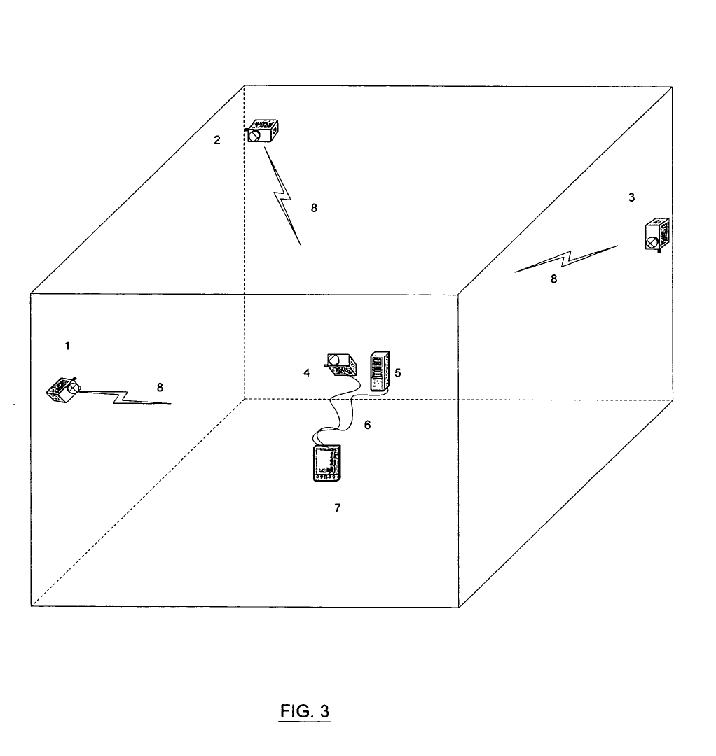

### DETAILED DESCRIPTION

Operation

The manner of using the device to record sensor measurement locations is first: to set two or more of the transmitters in a configuration with the distances known between them; second: attach the receiver to the sensor device; third: log receipts of transmission with date and time interval to the second of each with the parallel input of sensor readings; fourth: input recorded data onto screen for user or into file for later evaluation. By knowing the locations of the transmitters and the distance to the receiver from each transmitter, triangulation is made to determine Cartesian coordinates and the velocity of the sensor. Maps can be generated in real-time on the logging device or later as desired.

The device is able to determine the location of the receiver at all times by knowing where the transmitters are and then measuring the distance from those transmitters to the receiver. For example, when surveying a floor, two transmitters are placed at one end of the floor. About once a second, the transmitters send out an Ultrasound and RF pulse. The RF pulse tells the receiver which transmitter is sending the signal and when it will be sent. Then, the time of flight for the Ultrasound pulse is used to calculate the distance to the transmitter. By knowing the distance to two transmitters, the X,Y coordinate is calculated through trigonometry. By knowing the distance to three transmitters, the X,Y,Z coordinate can be calculated.

### CONCLUSION, RAMIFICATIONS, AND SCOPE

Accordingly, the reader will see that the device to record sensor measurement locations is useful in assisting the user to accurately know the location of one or more sensor measurements and log all measurement locations over a small increment of time.

While the systems and methods of the present invention have proven to be particularly useful in the area of locating radioactive contamination, those skilled in the art can appreciate that the systems and methods can be used in a variety of different applications, such as in the areas of any measurable contaminate (physical or chemical). These and other features and advantages of the present invention will be set forth or will become more fully apparent in the description that follows and in the appended claims. The features and advantages may be realized and obtained by means of the instruments and combinations particularly pointed out in the appended claims. Furthermore, the features and advantages of the invention may be learned by the practice of the invention or will be obvious from the description, as set forth hereinafter.

The invention has been described in detail, with particular emphasis on the preferred embodiments, but it should be understood that variations and modifications within the spirit and scope of the invention may occur to those skilled in the art to which the invention pertains.

We claim:

1. Device to calculate and record sensor measurement locations comprising:
(a) plurality of transmitters comprising
i) ultrasound transmitter
ii) radio frequency transmitter
(b) plurality of receivers comprising
i) ultrasound receiver
ii) radio frequency receiver
(c) processing means connected to an output of said receivers, for determining based on the output from said receiver the location in Cartesian coordinates of the device; and
(d) display means controlled by the processing means to display results from said means for calculating coordinates, said results being indicative of the location of the sensor reading.
(e) device to record sensor measurement locations of claim 1.

2. Device to calculate Cartesian coordinates of an object comprising:
(a) plurality of transmitters comprising
i) ultrasound transmitter
ii) radio frequency transmitter
(b) plurality of receivers comprising
i) ultrasound receiver
ii) radio frequency receiver
(c) processing means connected to an output of said receivers, for determining based on the output from said receiver the location in Cartesian coordinates of the device; and
(d) display means controlled by the processing means to display results from said means for calculating coordinates, said results being indicative of the location of the sensor reading.

3. Device to calculate and record sensor measurement locations comprising:
(a) plurality of transmitters comprising
i) ultrasound transmitter
ii) radio frequency transmitter
(b) plurality of receivers comprising
i) ultrasound receiver
ii) radio frequency receiver

4. Device of claim 3 further comprising processing means connected to an output of said receivers, for determining based on the output from said receiver the location in Cartesian coordinates of the device; and

5. Device of claim 4 further comprising a display means controlled by the processing means to display results from said means for calculating coordinates, said results being indicative of the location of the sensor reading.

6. Device of claim 5 further comprising a means to record the sensor measurements and locations.

7. Sensor locating device comprising:
(a) a plurality of transmitting means for ultrasound and RF signals
(b) a receiving means for the RF signals
(c) a receiving means for the ultrasound signals
(d) a processing means to calculate distance to transmitting means of 1(a).
(e) a processing means to calculate Cartesian coordinates of receiving means of 1b and 1c
(f) display means controlled by the processing means to display results from processing means, said results being indicative of the location of he receiver means.

8. Device of claim 7 further comprising a means to electronically interface the processing means to a sensor and receive its output

9. Device of claim 7 further comprising a means to record the output from the sensor of claim 8.

10. Device of claim 7 further comprising a means to display the location of sensor readings on a visual map.
